(19) United States
(12) Patent Application Publication
(10) Pub. No.: US 2012/0262488 A1
(43) Pub. Date: Oct. 18, 2012

(54) Method and Apparatus for Facilitating Text Editing and Related Computer Program Product and Computer Readable Medium

(75) Inventors: Huanglingzi Liu, Beijing (CN); Juha-matti Kalevi Kyyra, Somero (FI); Yongguang Guo, Beijing (CN)

(73) Assignee: NOKIA CORPORATION, Espoo (FI)

(21) Appl. No.: 13/518,319

(22) PCT Filed: Dec. 23, 2009
(86) PCT No.: PCT/CN2009/075875

§ 371 Date: Jun. 21, 2012

(51) Int. Cl. G06T 3/40; G06T 3/60

(52) U.S. Cl. 345/649; 345/660

(57) ABSTRACT

The present invention provides a solution for facilitating text editing in a device. According to the solution of the present invention, a first editing region is provided displaying a plurality of inputted characters and a second editing region is provided, in which a subset of the inputted characters is displayed enlargedly for being edited on the basis of a language unit. When receiving an editing input to the second editing region, a joint update to corresponding characters in the second editing region and the first editing region is performed.

### FIELD OF THE INVENTION

The present invention generally relates to the field of text editing and, more particularly, to a method and apparatus for facilitating touch-based text editing and relevant computer program products and storage medium.

### BACKGROUND OF THE INVENTION

Nowadays, more and more potable devices, such as handheld phones, personal digital assistants (PDAs) and the like are equipped with a touch screen capable of simultaneously performing an input operation and a display operation in one device to replacing or at least partly replacing conventional alphanumeric and directional keys in terms of their functions. With the development of touch screen technique, touch screens have been one of the most important inputting tools in portable devices.

Although finger interaction with a touch screen is more intuitive and natural for most potable device users, a finger is perceived as lack of precision with respect to the touch screen. One reason for this is that the portable device is manufactured with a small size for portability and the size of its touch screen and the items that it can display are limited. In fact, in the situation of text editing in the screen of the portable device, users usually have difficulties in repositioning cursor and selecting a target to be edited.

There are various input modalities which can be used to edit text. Besides the conventional keyboard or soft-keyboard based input modalities, the input modalities based on speech recognition and handwriting recognition (with an electronic “pen”, a stylus or even a finger) are increasingly gaining popularity. However, in the real applications, it is difficult to maintain the accurate input performance across different operating conditions, especially with speech recognition and/or handwriting recognition technologies. The limitations of speech and/or handwriting recognition technology inevitably raise the issue of correcting recognition errors. Therefore, users need a mechanism to efficiently interact with the word or characters shown in the limited screen of the potable device so as to edit the inputted text and correct the errors in the inputted text.

For example, after selecting target word or characters, for example a misrecognized or mis-inputted word or character, users may need to input a new word or character to replace the selected one. The above-mentioned various input modalities can be used in this interactive correction procedure. How to fuse these input modalities and allow users to quickly edit text is very important to gain a smoothly and joyful user experience, which is also a design challenge in the limited portable device screen.

Therefore, there is a desire of a new mechanism for facilitating text editing in a portable device with a size-limited touch screen.

The above discussion is merely provided for general background information and is not intended to be used as a limitation to the scope of the claimed subject matters in the present application.

### SUMMARY OF THE INVENTION

To solve the technical problems in the prior art, the present invention proposes new interacting mechanism for facilitating text editing in a portable device with a size-limited touch screen, especially for the speech recognition recovery.

According to a first aspect of the present invention, there is provided a method for facilitating text editing. The method comprises: providing a first editing region displaying a plurality of inputted characters; providing a second editing region in which a subset of the inputted characters is displayed enlargedly for being edited on the basis of a language unit; performing, in responding to receiving an editing input to the second editing region, a joint update to corresponding characters in the second editing region and the first editing region.

According to a second aspect of the present invention, there is provided an apparatus for facilitating text editing. The apparatus comprising: means for providing a first editing region displaying a plurality of inputted characters; means for providing a second editing region in which a subset of the inputted characters is displayed enlargedly for being edited on the basis of a language unit; means for performing, in responding to receiving an editing input to the second editing region, a joint update to corresponding characters in the second editing region and the first editing region.

According to the third aspect of the present invention, there is provided a device. The device comprises a processor unit being configured to control said device; a memory storing computer program instructions which cause when running by the processor to perform a method for facilitating text editing in a potable device, the method comprising: providing a first editing region displaying a plurality of inputted characters; providing a second editing region in which a subset of the inputted characters is displayed enlargedly for being edited on the basis of a language unit; performing, in responding to receiving an editing input to the second editing region, a joint update to corresponding characters in the second editing region and the first editing region.

According to a fourth aspect of the present invention, there is provided a computer program product. The computer program comprises a computer readable storage structure embodying computer program code thereon for execution by a computer processor, wherein said computer program code is hosted by a device and comprises instructions for performing a method including: providing a first editing region displaying a plurality of inputted characters; providing a second editing region in which a subset of the inputted characters is displayed enlargedly for being edited on the basis of a language unit; performing, in responding to receiving an editing input to the second editing region, a joint update to corresponding characters in the second editing region and the first editing region.

### BRIEF DESCRIPTION ON THE DRAWINGS

As the present invention is better understood, other objects and effects of the present invention will become more apparent and easy to be understood from the following description, taken in conjunction with the accompanying drawings wherein:

FIG. 1 schematically shows a flow chart of a method for facilitating text editing according to one illustrative embodiment of the present invention;

FIG. 2 schematically shows the main view of a user interface according to one illustrative embodiment of the present invention;

FIG. 3 schematically shows a view of a user interface for moving a cursor, according to one illustrative embodiment of the present invention;

FIG. 4A schematically shows views of a user interface for browsing the plurality of inputted characters in the second editing region, according to one illustrative embodiment of the present invention;

FIG. 4B schematically shows views of a user interface for zooming in/zooming out the content in the second editing region, according to one illustrative embodiment of the present invention;

FIG. 4C schematically shows views of a user interface for zooming in/zooming out the content in the second editing region, according to one illustrative embodiment of the present invention;

FIG. 5A shows a view of a user interface for editing text by candidate list according to one illustrative embodiment of the present invention;

FIG. 5B shows another view of a user interface for editing text by candidate list according to one illustrative embodiment of the present invention;

FIG. 5C shows views of a user interface for editing text by candidate list according to one illustrative embodiment of the present invention;

FIG. 6A shows a view of a user interface for editing text by handwriting, according to one illustrative embodiment of the present invention;

FIG. 6B shows another view of a user interface for editing text by handwriting, according to one illustrative embodiment of the present invention;

FIG. 6C shows another view of a user interface for editing text by handwriting, according to one illustrative embodiment of the present invention;

FIG. 7A shows a view of a user interface for deleting text, according to one illustrative embodiment of the present invention;

FIG. 7B shows a view of a user interface for deleting text, according to one illustrative embodiment of the present invention;

FIG. 8 shows a view of a user interface for inputting symbols, according to one illustrative embodiment of the present invention;

FIG. 9 shows a portable device in which one illustrative embodiment of the present invention can be implemented;

FIG. 10 shows a configuration schematic of the portable device as shown FIG. 9.

Like reference numerals designate the same, similar, or corresponding features or functions throughout the drawings.

### DESCRIPTION OF THE PREFERRED EMBODIMENTS

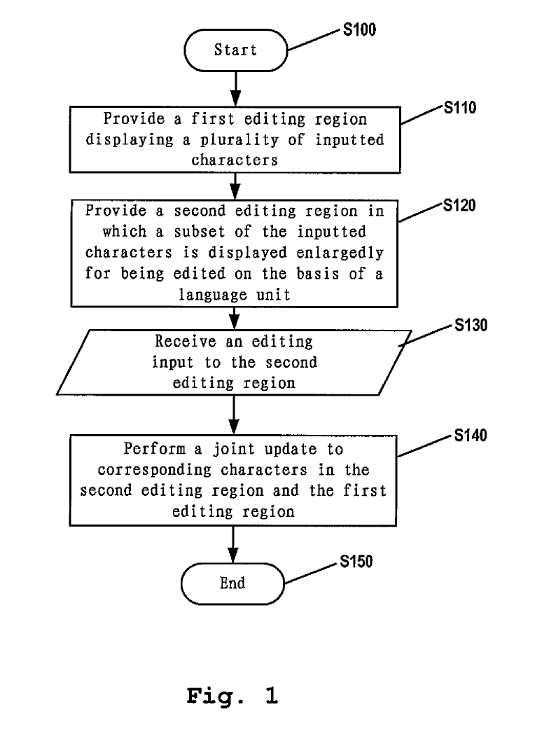

FIG. 1 schematically shows a flow chart of a method for facilitating text editing according to one illustrative embodiment of the present invention.

As shown in FIG. 1, at step S100, the flow of the method for facilitating text editing according to one illustrative embodiment of the present invention starts.

At step S110, a first editing region displaying a plurality of inputted characters is provided in a user interface. The plurality of inputted characters are, for example, resulted from speech-to-text recognition, handwriting recognition, optical character recognition (OCR) and/or the result of captured keystroke. Usually, a user would like to perform the input on the basis of natural sentences or even natural paragraphs, which expresses a complete purport. The first editing region functions as the overview and provides the user with a contextual view of whole text including the plurality of inputted characters. As limited by the size of the screen of the portable device, the plurality of inputted characters displayed by the first editing region is preferably with a scaled-down size.

At step S120, a second editing region in which a subset of the inputted characters is displayed enlargedly for being edited on the basis of a language unit is provided. The subset of the inputted characters which needs to be further edited or corrected can be for example selected by the user from the first editing region via a selecting means and shown in the second editing region. Preferably, the selected subset of the inputted characters shown in the second editing region can be edited on the basis of a minimal language unit, for example, a Chinese character in Chinese, a word or even a character of a word in English. The second editing region functions as a detail view of the selected characters and allows the user to view them in detail and interact with respective characters to make error corrections or further editing. In a preferred embodiment, the second editing region can be flipped and/or scanned to enable a navigation of the detailed text as shown in the first editing region. In the most cases, the first editing region and the second editing region are configured to be displayed simultaneously, so as to provide the user both the contextual view and enlarged detailed view of the text.

At step S130, an editing input to the second editing region is received. Editing inputs include any type of inputs for making text editing, for example, moving cursor, deleting, selecting character(s), selecting an editing modality, adding a new character or symbol, and so on.

With reference to the following discussion of the present invention, those skilled in the art will appreciate that the present invention can support any type of the editing input by configuring corresponding processing for supported input types. That is, the present invention will not be restricted to any specific input type discussed as examples in the present disclosure, but can be applicable to any new editing scenario which may require performing scenario-specific inputs of new types.

At step S140, a joint update to corresponding characters in the second editing region and the first editing region is performed. In fact, the first editing region and second editing region are associated with each other. When the received input to the second editing region results in a change of the enlarged characters displayed in the second editing region, the corresponding characters as shown in the first editing region will be updated jointly, to display in the first editing region the overview of the whole text containing the corresponding change.

At step S150, the flow of the method for facilitating text editing according to one illustrative embodiment of the present invention ends.

With the illustration of FIG. 1, the method for facilitating text editing according to one illustrative embodiment of the present invention is described. Hardware, software and the combination of both, which can be configured to provide the above functionalities, are well known in the art and will not be set forth herein in detail, for the purpose of emphasizing the core concept of the present invention.

Hereafter, with respect to the figures showing views of the user interface according to illustrative embodiments of the present invention, the details and advantages of the present invention will be more apparent.

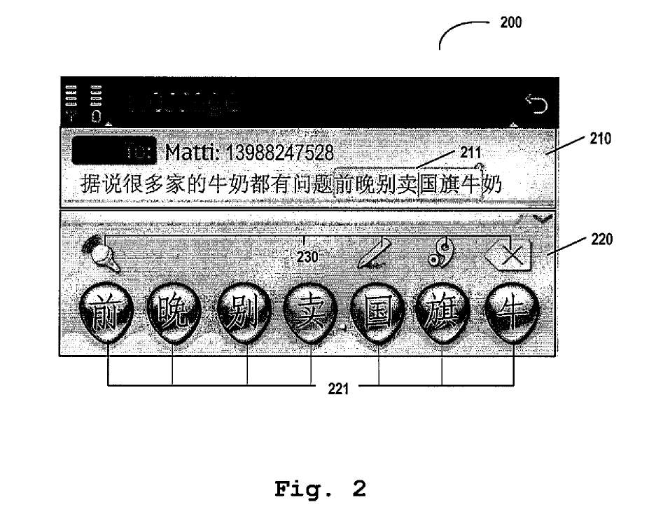

FIG. 2 schematically shows the main view of a user interface according to one illustrative embodiment of the present invention. Therein, reference numeral 200 denotes a user interface according to one illustrative embodiment of the present invention for a message application; reference numeral 210 denotes a first editing region of the user interface 200; and reference numeral 220 denotes a second editing region of the user interface 200.

As shown in FIG. 2, a plurality of inputted characters, which can be resulted for example from speech-to-text recognition, handwriting recognition, optical character recognition (OCR) and/or the result of captured keystroke, are displayed in the first editing region 210 of the user interface 200. As an overview of the inputted text, the first editing region 210 displays the whole text which has been inputted to the message application. Due to limitation of the screen size, an individual character displayed in the overview of the first editing region 210 are typically scaled down and with a small size, which is substantially difficult to be interacted with individually by using a fingertip of the user.

The second editing region 220 of the user interface 200 is provided horizontally under the first editing region 210. Of course, different layout for the second editing region 220 relative to the first editing region 210 can also be adopted, which will not make any limitation to the protection scope of the present invention. In the second editing region 220, a subset of the inputted characters selected from the first editing region 210 via a selecting means 211 such as a hint box or a sliding line is displayed in an enlarged style. As shown in FIG. 2, multiple characters (as an example, 7 characters shown in FIG. 2) which are selected by the selecting means 211 in the first editing region 210 are displayed enlargedly in the second editing region 220 as buttonized characters 221. Each button 221 represents one language unit such as a single character or a word which can be edited independently. In a preferable implementation, a minimal language unit can be enlarged in one button. The user may also configure the buttons to show his/her desired language units in these buttons. Since each button represents a language unit, the user may perform text editing/error correction on the basis of the buttons 221 (i.e., the language units represented by the buttons) to update the inputted text. The first editing region 210 and the second editing region 220 are associated with each other. When the user performs text editing/error correction on the buttons 221, a joint update is performed with respect to characters shown in the corresponding buttons 221 of the second editing region 220 and corresponding characters shown in the first editing region 210.

The user interface 200 may optionally contain several functional buttons 230 to enable corresponding functionalities for facilitating text editing. As shown in FIG. 2, the functional buttons 230 includes input mode buttons, such as a speech input button for activating speech recognition mode, a handwriting input button for activating a handwriting mode, a symbol input button for activating a mode for inputting symbols; and editing operation buttons, such as a deleting operation button for deleting characters or symbols selected in the text, inserting operation button for inserting characters or symbols into the selected position of the text; and the like. Additionally and or alternatively, specific gestures that the user makes on the touch screen of the portable device can be designated to respective functionalities. When a specific gesture is detected, corresponding functionalities will be enabled. Those skilled in the art can appreciate that functionality buttons and/or gestures designated to respective functionalities can be designed on the demand of applications and/or depending upon user preferability.

For example, the user begins speech input by pressing the speech input button in the user interface. When the user ends this speech input procedure for example by pressing again the speech input button, the result of speech recognition is shown in the first editing region 210, which usually contains a plurality of speech-inputted characters. The hint box 211 of a certain length (acting as the selecting means in this example) appears at its default location (for example, the end) of the speech-inputted text displayed in the first editing region 210. The user may change the location of the hint box 211 by directly clicking desired location in the first editing region 210 or dragging the hint box 211 to the desired location. The hint box 211 selects a subset of the inputted characters shown in the first editing region 210. Enlarged version of the characters in the hint box 211 is displayed in the second editing region 220 as buttonized characters. In other word, the hint box 211 gives the user a hint of which part of the inputted characters in the first editing region 210 is visible in the second editing region 220. As an advantageous option, both the hint box 211 of the first editing region 210 and the second editing region 220 can be activated or hided in responding to specific indication of the user.

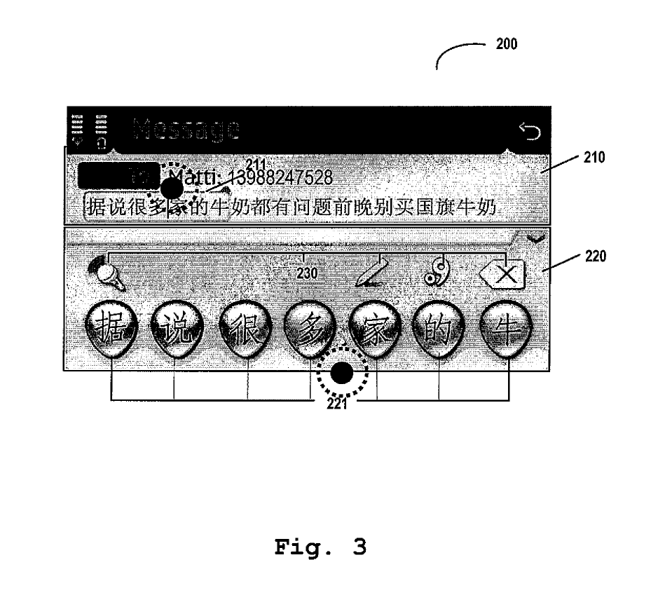

FIG. 3 schematically shows a view of a user interface for moving a cursor, according to one illustrative embodiment of the present invention.

As shown in FIG. 3, the operation of moving the cursor can be performed both in the first and the second editing regions 210, 220. Specifically, the user may click somewhere in the first editing region 210 to move the cursor in the overview of the inputted text; the user may also tap a space between two buttonized characters 221 in the second editing region 220. Regardless in which one of the first and second editing regions the movement of the cursor is occurred, the location of the cursor in the other of the first and second editing regions will be updated accordingly.

Since the hint box 211 can be configured to be moved following the cursor, the relative location of the hint box 211 and the cursor should be considered in practice. In one implementation, it may predefined that the center of the hint box 211 always follows the user's fingertip by default and the cursor always also follows the user's fingertip. If the user clicks somewhere in the beginning/last characters within the length of the hint box 211, the hint box 211 will cover the beginning/last characters within the length of the hint box 211 and the cursor should follow the user's fingertip. In the case of the inputted characters less than the default length of the hint box 211, the length of the hint box 211 can be configured to be changed according to the text length.

It should be noted that as the subset of the inputted characters displayed in the second editing region 220 will be changed accordingly when moving the hint box 211 of the first editing region 210, it is possible to browse in the second editing region 220 all the inputted text by clicking a desired location of the hint box 211 or dragging the hint box 211 in the first editing region 210.

Additionally and/or alternatively, the second editing region 220 per se can be provided with a mechanism for browsing the text.

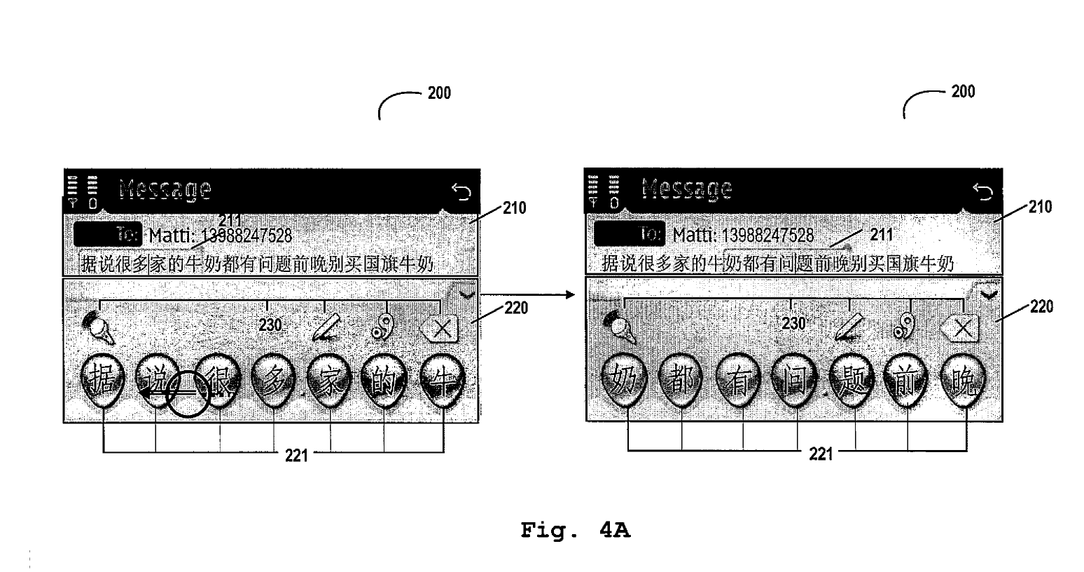

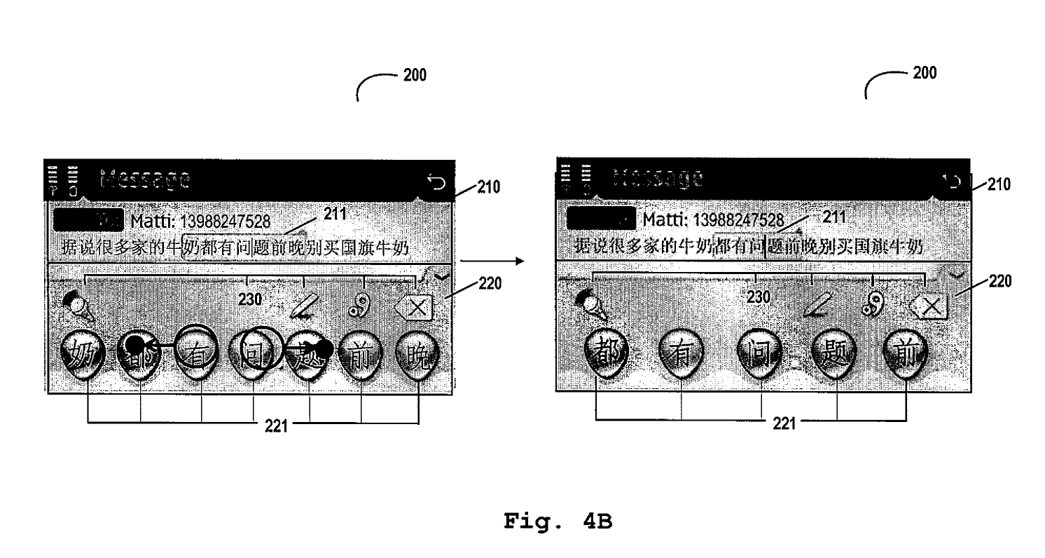

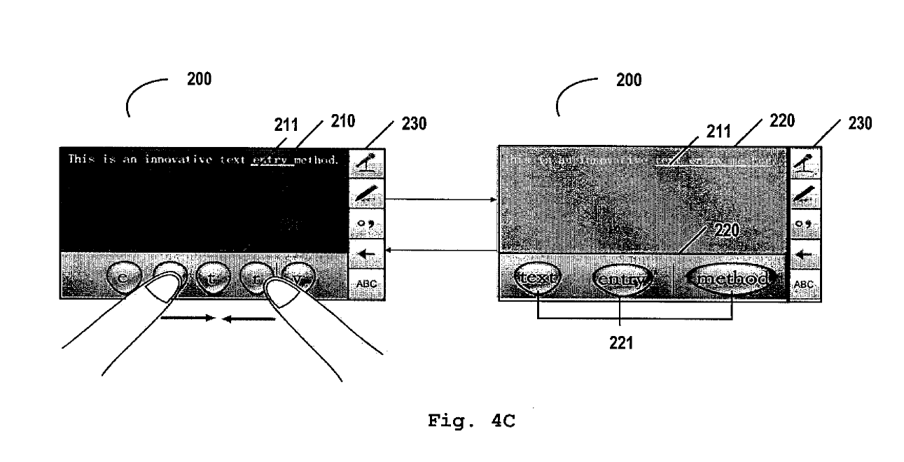

FIG. 4A schematically shows views of a user interface for browsing the plurality of inputted characters in the second editing region, according to one illustrative embodiment of the present invention.

As shown in FIG. 4A, the user for example can flick the second editing region 220 to page down or page up the content shown in the second editing region 220 and/or flip the second editing region 220 to left or right to view the previous or next set of characters and/or scan the second editing region 220 to shift characters to left or right one at a time (a slower and more controlled version of flipping). The mechanism for browsing allows the user to make detailed text navigation in the second editing region 220. When the second editing region 220 is flicked, flipped or scanned, the hint box 211 in the first editing region 210 is moved accordingly.

FIG. 4B schematically shows views of a user interface for zooming in/zooming out the content in the second editing region, according to one illustrative embodiment of the present invention.

In order to meet different requirements in navigation, the characters in the second editing region 220 is preferably configured to be zoomed in or zoomed out, so that the user can dynamically change the number of the characters (as the language units) shown in the second editing region 220, as shown in FIG. 4B, and/or the language unit per se based on which the second editing region 220 shows the characters as shown, in FIG. 4C. For example, in response to detecting the user' s indication, for example, a pinching gesture in the second editing region 220, the second editing region 220 is zoomed in or zoomed out to change the number of characters displayed in the second editing region 220. If the number after zooming in or zooming out is beyond a predetermined range for the number of characters which the second editing region 220 is configured to display, the language unit presented by each button 221 of the second editing region 220 can be changed from a single character to a word or from a word to a single character. Although the examples shown in FIGS. 4B and 4C is based on two pieces of text respectively in Chinese and English, the above described principle can be applicable to any kind of languages with some appropriate adjustments.

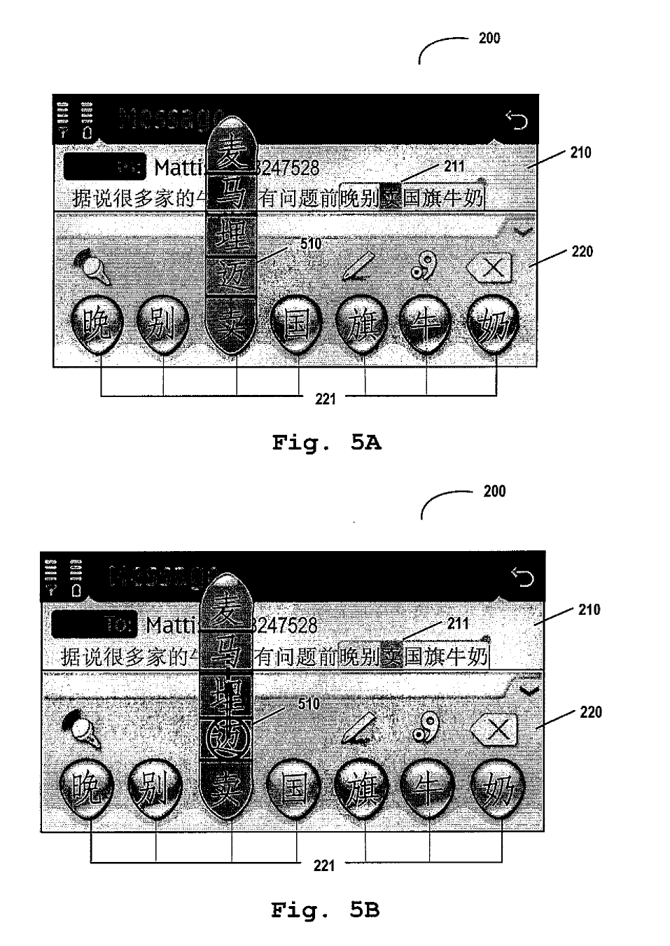

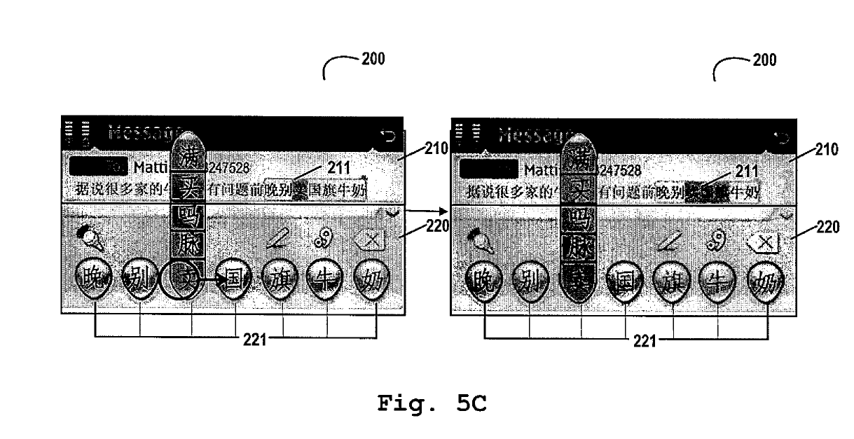

FIGS. 5A-5C show views of a user interface for editing text by candidate list according to one illustrative embodiment of the present invention.

In the second editing region 220, the buttonized characters 221 in the second editing region 220 can be activated to reveal a candidate list 510 of statistically relevant characters. As shown in FIG. 5A, the user taps the buttonized character and then the candidate list 510 pops up to show the candidate list 510, which can be generated according to any known algorithm in the art for prompting candidates of an inputted character or word. Once some buttonized character is activated, the cursor may be hidden in the second editing region 220 and the corresponding character in the first editing region 210 are highlighted in the hint box 211. The user may tap the activated buttonized character again to deactivate the character and hide the candidate list 510. The cursor may appear at the original location of the second editing region 220 and the corresponding character in the first editing region 210 are de-highlighted in the hint box 211.

As shown in FIG. 5B, the candidate list 510 for each of the buttonized characters 221 can be flipped upwards and downwards to reveal more candidate characters. Upon a character is selected from the candidate list 510, the original activated buttonized character in the second editing region 220 will be replaced by the selected one. At the same time, a joint update is also performed in the first editing region 210 accordingly. In a preferred implementation, the candidate list 510 is configured to be flipped along a second direction while the second editing region 220 is configured to be flipped along a first direction, wherein the first and the second directions are substantially perpendicular to each other.

As shown in FIG. 5C, the user may drag along in the second editing region 220 to select multiple buttonized characters to be activated. After the current buttonized character is corrected/deselected, a next character of the selected buttonized characters in the second editing region 220 will be activated to show its candidate list 510. If a buttonrized character in the second editing region 220 is replaced with a selected candidate character, it is preferred that the candidate list 510 of the next buttonized character is dynamically changed according to the user's correction. Similarly, as multiple characters are selected in the second editing region 220, the corresponding characters in the first editing region 210 are highlighted in the hint box 211. The user may tap other enlarged character in the second editing region 220 beyond the selection to deselect the multiple characters.

In order to correct errors in the text or further edit the text, a handwriting mode can be activated in the user interface 200.

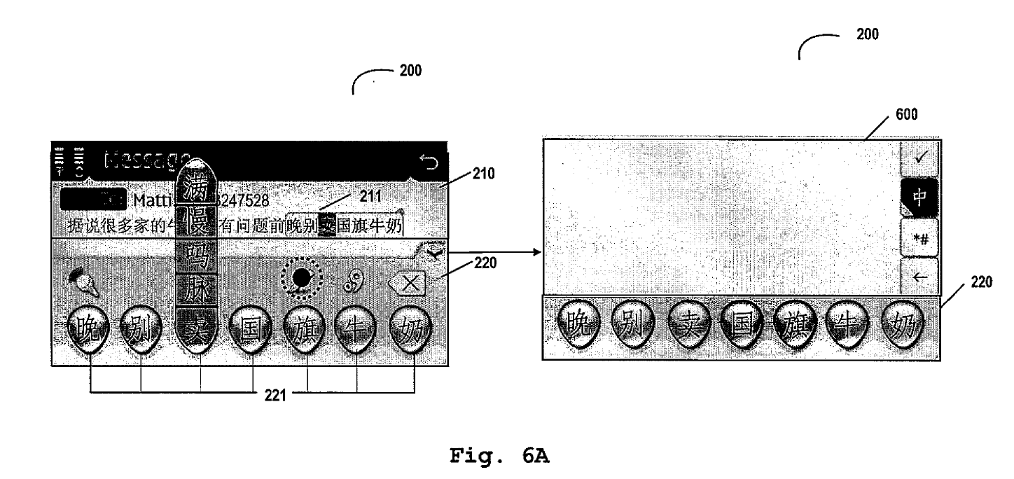

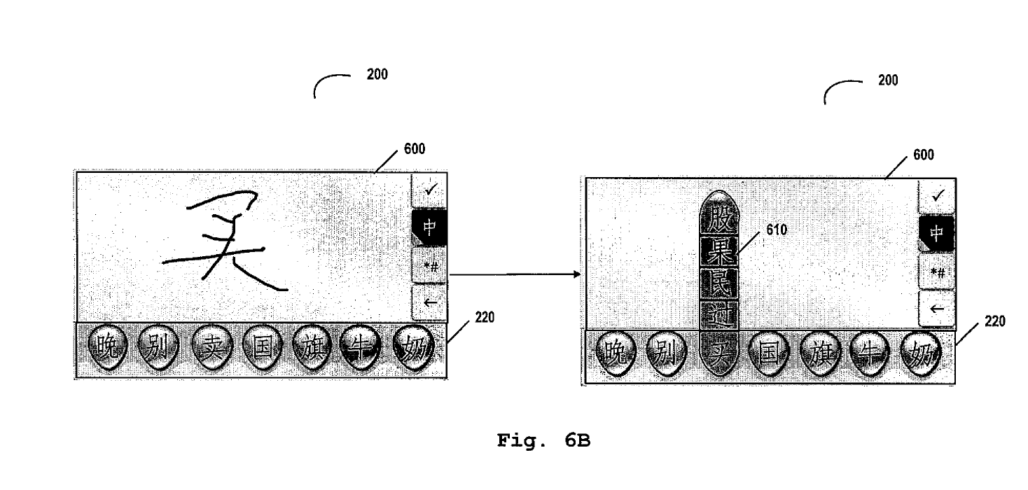

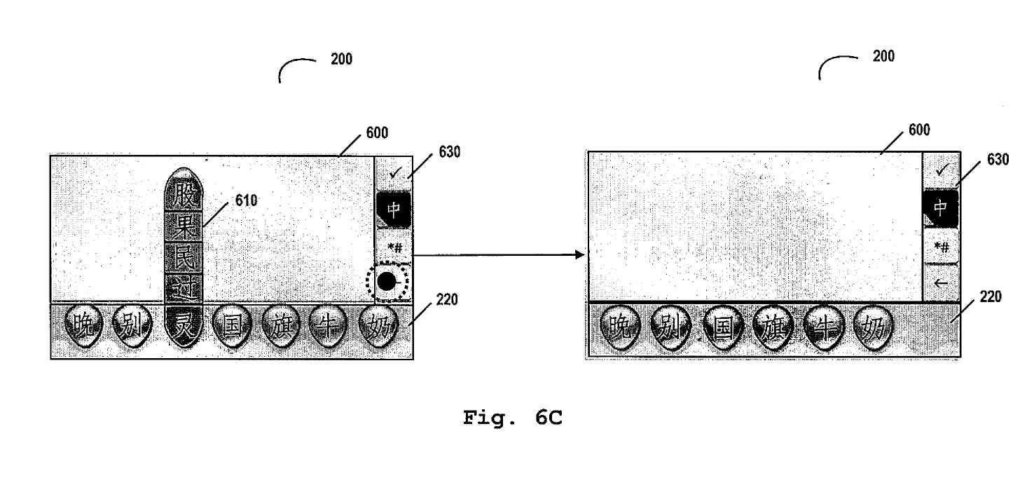

FIGS. 6A-6C shows views of a user interface for editing text by handwriting, according to one illustrative embodiment of the present invention.

The user may, for example, click the handwriting input button in the user interface 200, and then the handwriting pane 600 pops up in the user interface 200, in which the first editing region 210 can be hidden or defocused while the second editing region 220 appears along with the handwriting pane 600, as shown in FIG. 6A.

With reference to FIG. 6B, after writing, handwriting recognition is performed and the best predicted candidate will replace the character appearing in the current activated button in the second editing region 220 or be inserted into the current location of the cursor (not shown). Preferably, a handwriting candidate list 610 of the handwriting mode can be popped up to enable the user search for the desired character. The handwriting candidate list 610 of the handwriting mode can be flipped upwards and downwards with the user's specific gestures. Once the user taps one candidate to confirm the handwriting recognition, the handwriting candidate list 610 will be hidden and the selected candidate will replace the character appearing in the current activated button in the second editing region 220 or be inserted into the current location of the cursor. After the confirmation, the character can be deselected and the cursor can appear just behind the character. The user can continue the handwriting process if he or she could not find the desired character in the handwriting candidate list 610.

As shown in FIG. 6C, along with the handwriting pane 600, multiple functional buttons 630 can be provided to enable corresponding functionalities for facilitating handwriting input process. In the example shown in FIG. 6C, the functional buttons 630 include a confirmation button, an input language switching button, a symbol input button and a deleting button. For example, if the user clicks the deleting button on the handwriting pane 600, then the candidate list 610 and the selected buttonized character in the second editing region 220 will be deleted. If there is no character being selected, then clicking the deleting button will delete the character immediate before the cursor.

It should be appreciated that although in the handwriting mode, the first editing region 210 is invisible or defocused, the text contained in the first editing region is also updated along with the second editing region 220. When the user switches off the handwriting pane 600, the first editing region 210 will display the updated text.

In the above described embodiments with reference to FIGS. 6A-6C, handwriting recognition as an example of various input modalities is used to correct the errors in the inputted characters or further edit the inputted text. However, those skilled in the art can appreciate that other modalities are also applicable in the embodiments of the present invention. For example, the user may activate a pane for speech recognition or for virtual keyboard input, to correct errors in the inputted characters or further edit the inputted text in conjunction with the second editing region 220. With reference to the above description, those skilled in the art can easily conceive a lot of variations and modifications in this regard, which will not be discussed here in detail.

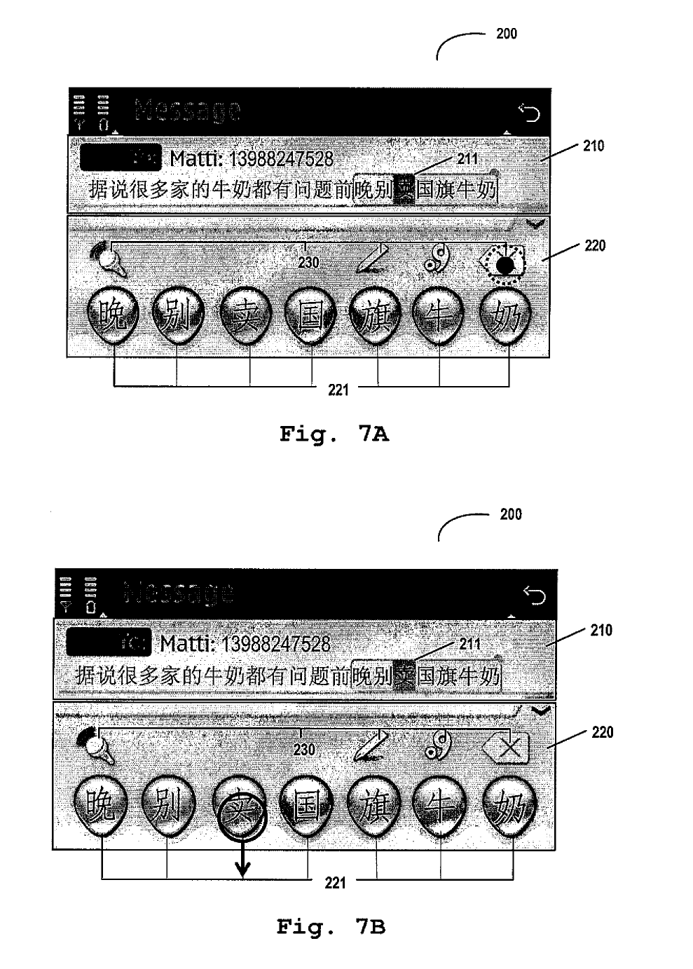

FIGS. 7A-7B show views of a user interface for deleting text, according to one illustrative embodiment of the present invention.

To delete one or more inputted characters, the user needs to select target character(s) in the second editing region 220, for example, by dragging along in the second editing region 220, or put the cursor to a desired location of the second editing region 220. Then, the user may enable a deleting operation in the way that is supported by the system. FIGS. 7A and 7B illustrate two applicable examples. In the example shown in FIG. 7A, the user presses the deleting button in the user interface 200 to enable a deleting operation; while in the example shown in FIG. 7B, the user make a gesture on the user interface 200 to drag the target buttonized characters down to make them out of the second editing region 220. After deleting, a joint update will be performed in both first editing region 210 and the second editing region 220.

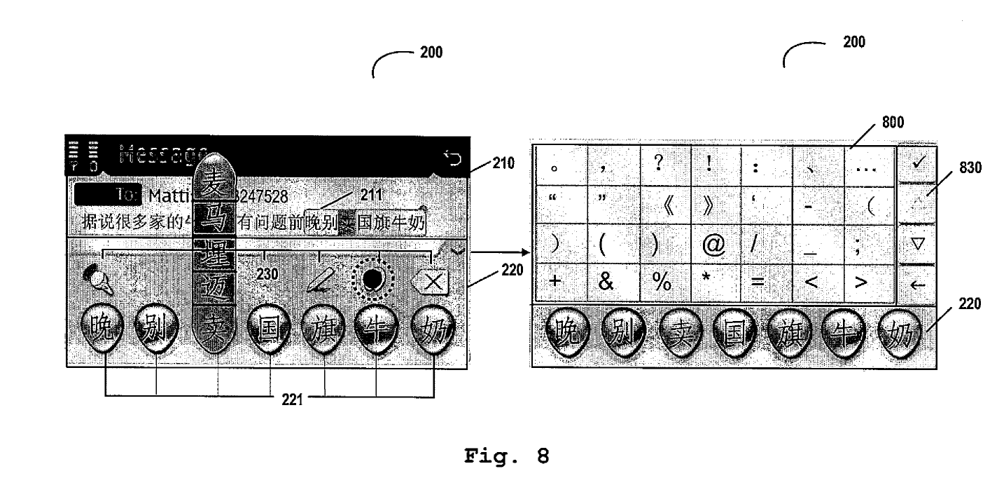

FIG. 8 shows a view of a user interface for inputting symbols, according to one illustrative embodiment of the present invention.

As shown in FIG. 8, a symbol pane 800 can be activated to facilitate symbol input, for example, by pressing a symbol input button in the user interface 200 or making some predefined gesture. The symbol pane 800 is displayed in conjunction with the second editing region 220. When the symbol pane 800 is activated, the first editing region 210 will become invisible or defocused. The user designates the location in the second editing region 220 where he or she would like to insert a symbol and then taps a desired symbol in the symbol pane 800. The symbol pane 800 may further include functional buttons 830 to support additional operations with respect to the symbol pane 800, for example, page down button, page up button, deleting button, confirming button and the like.

FIG. 9 shows a portable device in which one illustrative embodiment of the present invention can be implemented.

The mobile terminal 900 comprises a speaker or earphone 902, a microphone 906, a touch display 903 and a set of keys 904 which may include virtual keys 904a, soft keys 904b, 904c and a joystick 905 or other type of navigational input device.

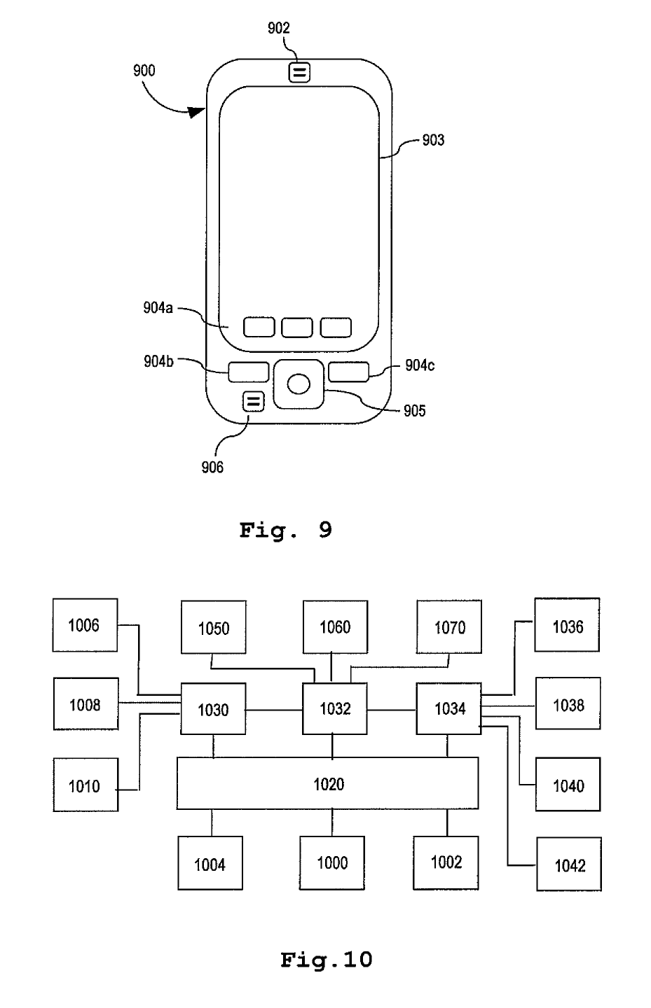

FIG. 10 shows a configuration schematic of the portable device as shown FIG. 9.

The internal component, software and protocol structure of the mobile terminal 900 will now be described with reference to FIG. 9. The mobile terminal has a controller 1000 which is responsible for the overall operation of the mobile terminal and may be implemented by any commercially available CPU (“Central Processing Unit”), DSP (“Digital Signal Processor”) or any other electronic programmable logic device. The controller 1000 has associated electronic memory 1002 such as RAM memory, ROM memory, EEPROM memory, flash memory, or any combination thereof. The memory 1002 is used for various purposes by the controller 1000, one of them being for storing data used by and program instructions for various software in the mobile terminal. The software includes a real-time operating system 1020, drivers for a man-machine interface (MMI) 1034, an application handler 1032 as well as various applications. The applications can include a message text editor 1050, a hand writing recognition (HWR) application 1060, as well as various other applications 1070, such as applications for voice calling, video calling, sending and receiving Short Message Service (SMS) messages, Multimedia Message Service (MMS) messages or email, web browsing, an instant messaging application, a phone book application, a calendar application, a control panel application, a camera application, one or more video games, a notepad application, etc. It should be noted that two or more of the applications listed above may be executed as the same application.

The MMI 1034 also includes one or more hardware controllers, which together with the MMI drivers cooperate with the first display 1036/903, and the keypad 1038/904 as well as various other I/O devices such as microphone, speaker, vibrator, ringtone generator, LED indicator, etc. As is commonly known, the user may operate the mobile terminal through the man-machine interface thus formed.

The software can also include various modules, protocol stacks, drivers, etc., which are commonly designated as 1030 and which provide communication services (such as transport, network and connectivity) for an RF interface 1006, and optionally a Bluetooth interface 1008 and/or an IrDA interface 1010 for local connectivity. The RF interface 1006 comprises an internal or external antenna as well as appropriate radio circuitry for establishing and maintaining a wireless link to a base station. As is well known to a man skilled in the art, the radio circuitry comprises a series of analogue and digital electronic components, together forming a radio receiver and transmitter. These components include, band pass filters, amplifiers, mixers, local oscillators, low pass filters, AD/DA converters, etc.

The mobile terminal also has a SIM card 1004 and an associated reader. As is commonly known, the SIM card 1004 comprises a processor as well as local work and data memory.

The various aspects of what is described above can be used alone or in various combinations. The teaching of this application may be implemented by a combination of hardware and software, but can also be implemented in hardware or software. The teaching of this application can also be embodied as computer program product on a computer readable medium, which can be any material media, such as floppy disks, CD-ROMs, DVDs, hard drivers, even network media and etc.

The specification of the present invention has been presented for purposes of illustration and description, and is not intended to be exhaustive or limited to the invention in the form disclosed. Many modifications and variations will be apparent to those of ordinary skill in the art. It is understood by those skilled in the art that the method and means in the embodiments of the present invention can be implemented in software, hardware, firmware or a combination thereof.

Therefore, the embodiments were chosen and described in order to better explain the principles of the invention, the practical application, and to enable others of ordinary skill in the art to understand that all modifications and alterations made without departing from the spirit of the present invention fall into the protection scope of the present invention as defined in the appended claims.

1-24. (canceled)

25. A method for facilitating text editing, comprising:
providing a first editing region displaying a plurality of inputted characters;
providing a second editing region in which a subset of the inputted characters is displayed enlargedly for being edited on the basis of a language unit; and
performing, in responding to receiving an editing input to the second editing region, a joint update to corresponding characters in the second editing region and the first editing region.

26. The method according to claim 25, comprising:
selecting, in the first editing region, the subset of inputted characters enlarged shown in the second editing region and displaying what part of the plurality of inputted characters is visible in the second editing region.

27. The method according to claim 25, wherein
the subset of inputted characters are displayed enlarged in the second editing region as buttonized language units.

28. The method according to claim 25, wherein
the second editing region is configured to allow a detailed navigation through the plurality of the inputted characters in the first editing region.

29. The method according to claim 25, wherein
the second editing region is configured to enable to be zoomed in or zoomed out to dynamically change the number of the language units buttonized in the second editing region and/or modify the language unit based on which the second editing region currently displays the subset of the inputted characters.

30. The method according to claim 27, comprising
popping up, in responding to activating a buttonized language unit in the second editing region, a candidate list to prompt candidates for the activated language unit;
replacing, in responding to selecting a candidate from the candidate list, the activated language unit with the selected candidate in the second editing region; and
performing a joint update in the first editing region accordingly.

31. The method according to claim 30, wherein
the candidate list is configured to be flipped to reveal more candidates.

32. The method according to claim 31, wherein
the second editing region is configured to be flipped along a first direction and the candidate list is configured to be flipped along a second direction, wherein the first and the second directions are substantially perpendicular to each other.

33. The method according to claim 30, comprising
activating, in responding to a user's indication, a pane of a input modality for correct the errors in the inputted characters or further edit the inputted text.

34. The method according to claim 33, wherein
the input modality includes one of:
handwriting recognition;
speech recognition; and
virtual keyboard input.

35. The method according to claim 25, wherein
the language unit at least includes a single character and a word.

36. An apparatus for facilitating text editing, comprising:
at least one processor; and
at least one memory storing computer program instructions;
the at least one memory and the computer program instructions being configured to, with the at least one processor, cause the apparatus to perform:
providing a first editing region displaying a plurality of inputted characters;
providing a second editing region in which a subset of the inputted characters is displayed enlargedly for being edited on the basis of a language unit; and
performing, in responding to receiving an editing input to the second editing region, a joint update to corresponding characters in the second editing region and the first editing region.

37. The apparatus according to claim 36,
further configured to select, in the first editing region, the subset of inputted characters enlarged shown in the second editing region and for displaying what part of the plurality of inputted characters is visible in the second editing region.

38. The apparatus according to claim 36, wherein
the subset of inputted characters are displayed enlarged in the second editing region as buttonized language units.

39. The apparatus according to claim 36, wherein
the second editing region is configured to allow a detailed navigation through the plurality of the inputted characters in the first editing region.

40. The apparatus according to claim 36, wherein
the second editing region is configured to enable to be zoomed in or zoomed out to dynamically change the number of the language units buttonized in the second editing region and/or modify the language unit based on which the second editing region currently displays the subset of the inputted characters.

41. The apparatus according to claim 38,
further configured to pop up, in responding to activating a buttonized language unit in the second editing region, a candidate list to prompt candidates for the activated language unit;
further configured to replace, in responding to selecting a candidate from the candidate list, the activated language unit with the selected candidate in the second editing region; and
further configured to perform a joint update in the first editing region accordingly.

42. The apparatus according to claim 41, wherein
the candidate list is configured to be flipped to reveal more candidates.

43. The apparatus according to claim 42, wherein
the second editing region is configured to be flipped along a first direction and the candidate list is configured to be flipped along a second direction, wherein the first and the second directions are substantially perpendicular to each other.

44. A computer program product comprising a computer readable storage structure embodying computer program code thereon for execution by a computer processor, wherein said computer program code is hosted by a device and comprises instructions for performing a method including:
providing a first editing region displaying a plurality of inputted characters;
providing a second editing region in which a subset of the inputted characters is displayed enlargedly for being edited on the basis of a language unit; and
performing, in responding to receiving an editing input to the second editing region, a joint update to corresponding characters in the second editing region and the first editing region.
